(19) United States
(12) Patent Application Publication
(10) Pub. No.: US 2018/0048940 A1
(43) Pub. Date: Feb. 15, 2018

(54) SYSTEMS AND METHODS FOR USING A HOME SECURITY SYSTEM TO ALERT A USER ABOUT A MEDIA EVENT

(71) Applicant: Rovi Guides, Inc., San Carlos, CA (US)

(72) Inventor: Edison Lin, Menlo Park, CA (US)

(21) Appl. No.: 15/236,624

(22) Filed: Aug. 15, 2016

(51) Int. Cl. H04N 21/488; H04N 21/439; H04N 21/4223; H04N 21/45; H04N 21/8545; H04N 21/442; H04N 21/436; H04N 21/422

(52) U.S. Cl. CPC H04N 21/4882; H04N 21/43615; H04N 21/4394; H04N 21/422; H04N 21/4532; H04N 21/4524; H04N 21/8545; H04N 21/44218; H04N 21/4223

(57) ABSTRACT

Systems and methods are provided herein for alerting a user about a media event using a home security application of the user. A media guidance application may determine that a media event is beginning at a given time, and may determine that a user whose profile indicates that the user would enjoy the media event is not consuming media corresponding to the media event at the given time. In response to determining that the user is not consuming the media at the given time, the media guidance application may access a home security application of the user, and may identify, using the home security application, the respective room within which the user is located at the given time. The media guidance application may then cause a speaker of a plurality of speakers that is within the respective room to alert the user that the media event is beginning.

### BACKGROUND

Home security systems are becoming ubiquitous and increasingly robust. The manner in which home security systems function in the related art is that various triggers may be set—such as the opening of a door, the detection of an intruder, and the like—which, when activated, cause an alarm to sound. For example, facial recognition is used in the related art to determine whether a person entering a home is an intruder, and if the person entering is an intruder, a pre-defined device will sound an alert, or a global alarm will be set off.

Home security systems in the related art generally include cameras, speakers, microphones, and the like throughout one's property. The cameras and microphones are generally used to detect a trigger condition, and the speakers (or a telephone or Internet connection) are used to alert the appropriate parties. The related art does not leverage the infrastructure provided by home security systems for media guidance purposes, nor does the related art consider dynamically choosing what devices of a home security system may be leveraged, to the exclusion of others, in order to provide media guidance.

### SUMMARY

Systems and methods are provided herein for alerting a user about a media event using a home security application of the user. The systems and methods leverage the existing infrastructure of a home security system to send alerts to targeted components of the home security system (e.g., a speaker that is in a room with a user whom the media guidance application is attempting to contact). In this manner, alerts, such as a reminder that a desired program is about to begin, are able to be sent to the user using the home security system's infrastructure. This may be useful, e.g., because users may not carry around personal devices when home, so they may not be reachable by a media guidance application in any other manner.

To this end, in some aspects of the disclosure, a media guidance application executed by control circuitry of a user equipment may determine that a media event is beginning at a given time. For example, the media guidance application may determine that a sporting match is about to begin.

In some embodiments, the media guidance application may determine that a user whose profile indicates that the user would enjoy media corresponding to the media event is not consuming the media event at the given time. For example, the media guidance application may determine that a given user of a home does not presently have his television set powered on and tuned to the sporting match, but may determine that the user would enjoy viewing the sporting match on the basis of information in the user's profile.

In some embodiments, in response to determining that the user is not consuming the media at the given time, the media guidance application may access a home security application of the user, where the home security application interfaces with a plurality of speakers, and where each speaker of the plurality of speakers is within a respective room of a home of the user. For example, the media guidance application may access a module that enables control over the home security system. As another example, the media guidance application may begin a session with the home security application, thus enabling the media guidance application to transmit commands and requests to the home security system and receive feedback.

In some embodiments, when the media guidance application is accessing the home security application of the user, the media guidance application may initiate a communication between the media guidance application and the home security application. For example, the media guidance application may transmit a request to the home security application. The media guidance application may then receive, from the home security application, information about the location of the user. For example, the home security application may locate the user using facial recognition technology on a camera integrated with the home security application. Ultimately, the accessing of the home security application may enable the media guidance application to issue alerts through the plurality of speakers.

In some embodiments, the media guidance application may identify, using the home security application, the respective room within which the user is located at the given time. In some embodiments, this identifying of the respective room may begin by the media guidance application accessing a plurality of cameras with which the home security application interfaces. For example, the cameras of a home security system that are scattered about a person's property may be accessed. The media guidance application may then detect, while accessing the plurality of cameras, an unidentified person in the respective room. The media guidance application may use facial recognition, by detecting facial characteristics of the unidentified person, in order to identify the unidentified person. The unidentified person may thus be identified as the user who enjoys the sporting event that is beginning at the given time.

In some embodiments, each of the plurality of speakers and the plurality of cameras is hardwired into the home of the user. For example, the speakers, cameras, and other components of the home security system are not portable components (e.g., cell phone, tablet, portable camera, and other easily movable devices). Rather, the home security system components are permanently or semi-permanently affixed to the user's property.

In some embodiments, the media guidance application may identify, using the home security application, the respective room within which the user is located at the given time comprises estimating a room in which the user is located based on a location of a device owned by the user. For example, indoor location technology may be used to estimate where a user is within a home based on where the user's device is in relation to various access points within the home.

In some embodiments, the media guidance application may cause, using the media guidance application, a speaker of the plurality of speakers that is within the respective room to alert the user that the media event is beginning. For example, if the user is in the kitchen at the given time, the media guidance application may cause a speaker of the user's home security system that is within the kitchen to alert the user that the media event is beginning.

In some embodiments, the media guidance application may, when causing the speaker of the plurality of speakers that is within the respective room to alert the user that the media event is beginning, cause no other speaker of the plurality of speakers to sound an alert that the media event is beginning. For example, if a user is in the kitchen, but there are speakers in the bedroom, in the garden, and in the den, the media guidance application may cause the kitchen speaker to alert the user, but may ensure that the speakers in the bedroom, garden, and den do not issue the alert. This may be achieved by the media guidance application generating a command that addresses the kitchen speaker, and is sent directly to the kitchen speaker (perhaps through a home security system gateway or gatekeeper). Alternatively, this may be achieved by the media guidance application transmitting the alert to all speakers of the home security system, and the media guidance application also transmitting a command to some speakers of the home security system to not sound that alert.

In some embodiments, the media guidance application may detect that a plurality of users whose profiles indicate that they would enjoy the media event are not consuming the media at the given time. For example, if a family of four lives in a home and two of them enjoy sporting events, the media guidance application may determine that each of those two people are not consuming the media if neither is viewing it at the given time. The media guidance application may identify a plurality of respective rooms within which the plurality of users are located at the given time. For example, the media guidance application may detect that the two users that enjoy the sporting event are in the den and the kitchen, and the two users that do not enjoy the sporting event are in the garden and the bedroom. The media guidance application may thus cause speakers in the den and the kitchen to alert those users that the media event is beginning.

In some embodiments, the media guidance application may determine that a different user whose profile indicates that the different user would not enjoy the media event is not consuming the media at the given time. For example, in a large household, someone other than the user may not enjoy the sporting event. The media guidance application, in response to determining that the different user is not consuming the media at the given time, may identify the respective room within which the different user is located at the given time. This identifying may be performed in the manners described above and below with respect to the user. The media guidance application may then cause a speaker of the plurality of speakers that is within the respective room within which the different user is located at the given time to refrain from alerting the different user that the media event is beginning. For example, the media guidance application may actively ensure that users whose profiles do not indicate an affinity for a media event not be alerted about that media event by a component of the home security system.

In some embodiments, the media guidance application may detect a voice command from the user that indicates a desire to consume the media relating to the media event. The media guidance application, in response to detecting the voice command, may identify a nearest device to the user that is suitable for consuming the media, and may cause the media to be generated for display at the nearest device. For example, the user is in the kitchen, and the user issues a command of “PLAY THE MEDIA EVENT HERE IN THE KITCHEN,” the media guidance application may determine that there is a tablet computer in the kitchen that is suitable for playing back the media event, and may cause the tablet to generate for display the media event.

In some embodiments, the media guidance application may detect a voice command that indicates a desire to listen to an audio component relating to the media event while the user is in the respective room. The media guidance application may thus reactively transmit the audio component to the speaker, and may cause the speaker to output the audio component of the media. Thus, the user may be able to listen to the media even when the user is preoccupied and cannot view the media.

In some embodiments, systems and methods are provided for alerting a user about a media event using a home security application of the user, the method comprising. To this end, a media guidance application may determine that a media event is beginning at a given time, and may determine that a user whose profile indicates that the user would enjoy the media event is not consuming media corresponding to the media event at the given time. In response to determining that the user is not consuming the media at the given time, the media guidance application may use an output device of a home security system to alert the user that the media event is beginning, wherein the output device is in a same room of a home as the user.

### BRIEF DESCRIPTION OF THE DRAWINGS

FIG. 1 depicts an illustrative embodiment of a home security system within a home that interacts with a media guidance application, in accordance with some embodiments of the disclosure;

FIG. 2 shows an illustrative embodiment of a display screen that may be used to provide media guidance application listings and other media guidance information, in accordance with some embodiments of the disclosure;

FIG. 3 shows another illustrative embodiment of a display screen that may be used to provide media guidance application listings, in accordance with some embodiments of the disclosure;

FIG. 4 is a block diagram of an illustrative user equipment (UE) device in accordance with some embodiments of the disclosure;

FIG. 5 is a block diagram of an illustrative media system in accordance with some embodiments of the disclosure;

FIG. 6 depicts an illustrative flowchart of a process for using a home security system to alert a user that a media event the user is likely to enjoy is about to begin, in accordance with some embodiments of the disclosure; and

FIG. 7 depicts an illustrative flowchart of a process for using a home security system to output an alert that media is beginning in rooms of a home where users are likely to enjoy the media, and not in rooms where users are unlikely to enjoy the media, in accordance with some embodiments of the disclosure.

### DETAILED DESCRIPTION

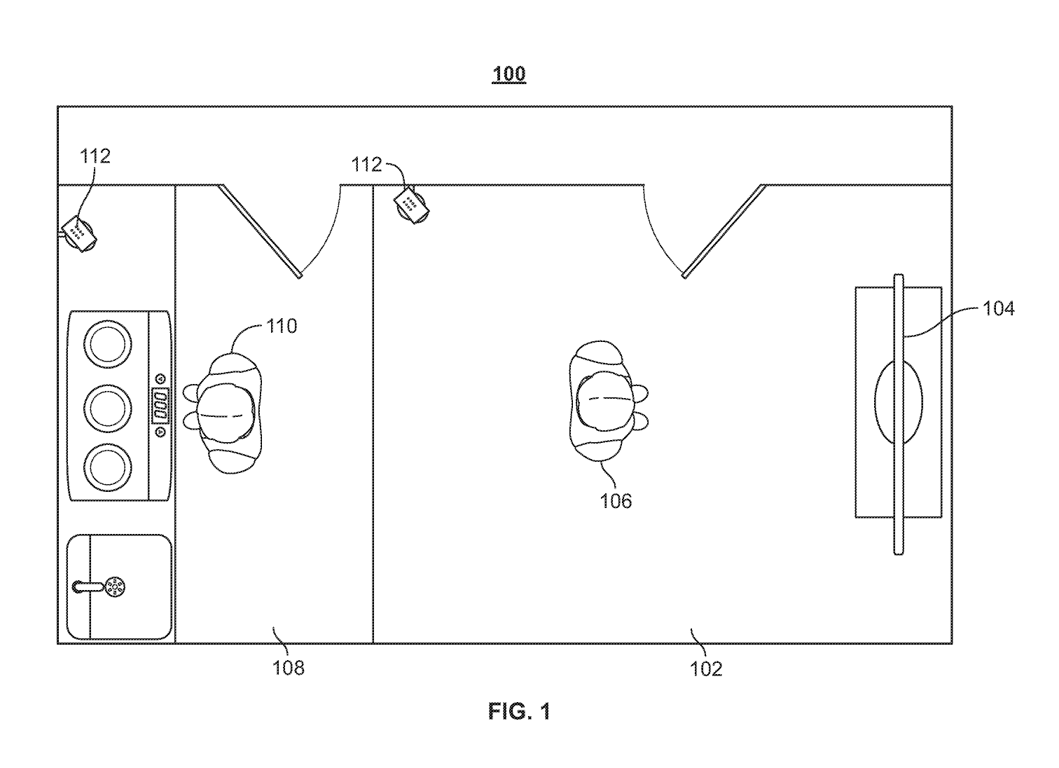

FIG. 1 depicts an illustrative embodiment of a home security system within a home that interacts with a media guidance application, in accordance with some embodiments of the disclosure. As used herein, the term “home security system” refers to a system where home security components, such as speakers, cameras, and other sensors and output devices, are used to detect events and alert residence of the home about those events. In some embodiments, each of the home security components is hardwired into home 100. For example, the speakers, cameras, and other components of the home security system are not portable components (e.g., cell phone, tablet, portable camera, and other easily movable devices). Rather, the home security system components are permanently or semi-permanently affixed to the user's property.

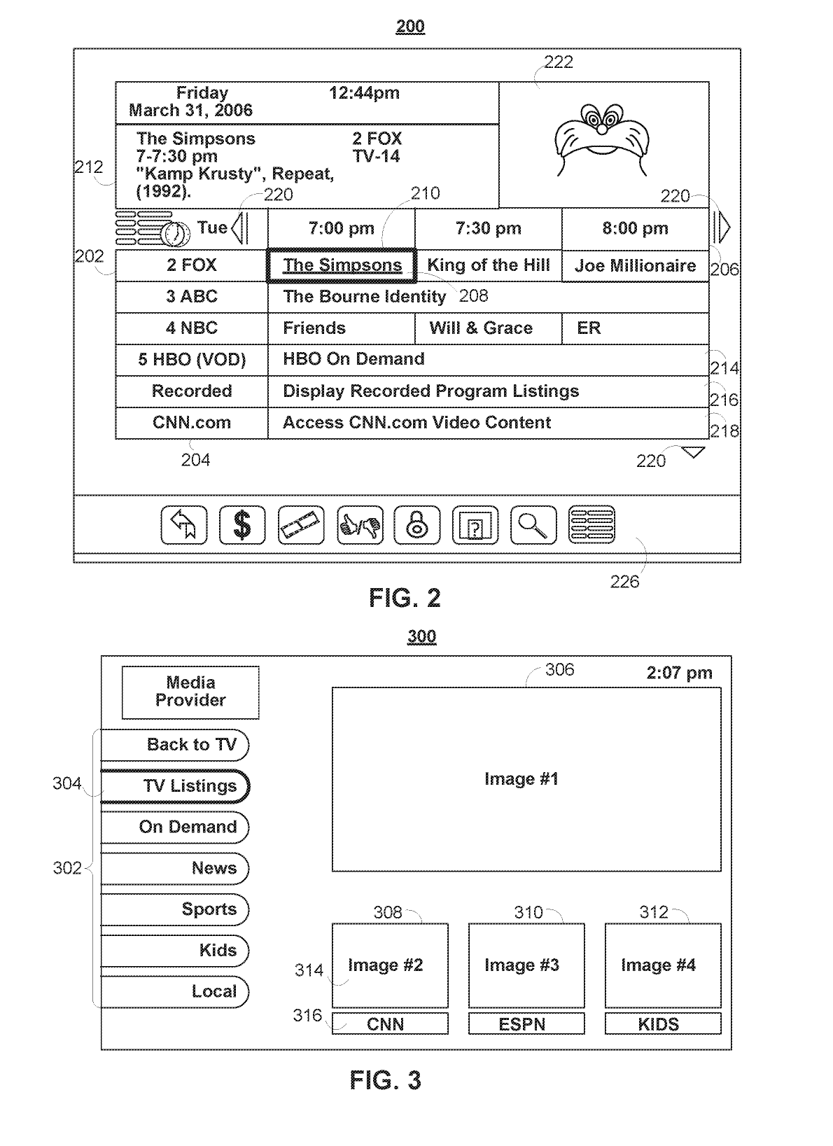

The home security components may be coordinated by a home security application. As used herein, the term “home security application” is a software application that includes logic for detecting events and alerting residence of the home about those events. The home security application may be a standalone application, or may be a module of a media guidance application (the term media guidance application is defined in detail below with respect to FIGS. 2-5).

FIG. 1 depicts two rooms in an exemplary home 100—living room 102, and kitchen 108—each of which include home security components 112, which may include sensors (e.g., cameras, microphones, etc.), output devices (e.g., speakers, displays, etc.), and the like. Exemplary home 100 may include any number of rooms, and each room may include any number of home security components 112. As depicted, living room 102 includes user equipment 104. While in FIG. 1, only living room 102 is depicted as including user equipment 104, any number of rooms may include user equipment 104. Person 106 and person 110 are in the living room and kitchen, respectively.

As described herein, the home security system of home 100 is enabled to alert a user about a media event by way of integration of the home security application that provides logic for the home security system with a media guidance application. Thus, the existing infrastructure of the home security system may be used to send alerts to targeted components of the home security system (e.g., home security component 112 in kitchen 108, which includes user 110, whom the media guidance application is attempting to contact).

In some embodiments, a media guidance application executed by control circuitry (e.g., of a user equipment, such as user equipment 104, or of a server) may determine that a media event is beginning at a given time. For example, a media guidance application may consult a database, such as a media guidance data source (described in detail with respect to FIGS. 2-5 below), which may indicate schedule data relating to media events. As used herein, the term “media event” refers to an event in media, such as a televised event (e.g., sporting event), a launch of an app or a website or web page, a time at which a live event (e.g., concert) begins, a time at which on-demand, OTT, or streaming content is released (e.g., a new episode of a series becomes available), and the like. The term “media corresponding to the media event” refers to the actual media consumed during the event (e.g., actual content of a launched website). Thus, the media guidance data source may indicate that a launch of a new music album from a band will be streamed on a website at 1:00 pm on Aug. 30, 2017, and the media guidance application may determine from this data that the media event of the launch of the music album will begin at that time.

In some embodiments, the media guidance application may determine that a user whose profile indicates that the user would enjoy media corresponding to the media event is not consuming the media at the given time. Following from the example above, person 110 may enjoy the band whose album is being released on Aug. 30, 2017 at 1:00 pm. The media guidance application may determine that person 110 enjoys the band by consulting a database, such as the media guidance data source, which may indicate profile information about person 110, such as the user's preferences.

The media guidance application may determine that person 110 is not consuming the media corresponding to the media event in any number of ways. In some embodiments, this determination may be made without use of home security components 112. For example, the media guidance application may determine, in the case of the music album launch on a website, or in the case of the beginning of a televised sporting match, that user equipment 104, which belongs to person 110, is not powered on, or is not tuned to or displaying the media corresponding to the media event. This determination may be made by the media guidance application directly querying user equipment 104 to determine that the media is not being output through user equipment 104 at that time.

In some embodiments, the media guidance application may use home security components 112 to determine that person 110 is not consuming the media corresponding to the media event. For example, a microphone of home security components 112 may be used to detect audio data being output by user equipment in person 110's home, such as user equipment 104. The audio data may be compared to audio data of the media, and if no match is detected, the media guidance application may determine that the user is not consuming the media.

Alternatively, or additionally, a camera of home security components 112 may be used to determine whether media corresponding to the media event is being consumed by user 110. For example, a camera may identify where in home 100 person 110 presently is. If person 110 is in kitchen 108, which does not have a user equipment device in it, the media guidance application may determine on this basis that person 110 is not presently consuming the media corresponding to the media event. Alternatively, or additionally, the camera may be used to analyze an image or video being output by a user equipment, such as user equipment 104, and may determine whether that image or video corresponds to the media event. If there is no match, the media guidance application may determine that person 110 is not consuming the media event.

In some embodiments, in response to determining that person 110 is not consuming the media corresponding to the media event at the given time, the media guidance application may access the home security application of the user in order to ultimately leverage home security components 112 to interact with the user. As discussed above, home security components 112 may be dispersed throughout home 100, and may include output components such as speakers. In order to access the home security application, in the case that the home security application is a stand-alone application that is separate from the media guidance application, the media guidance application may request permission to access features of the home security application. For example, the media guidance application may transmit a token or other authentication feature to the home security application in order to be authenticated to access the home security application. As another example, a user may have initially authorized the media guidance application to access the home security application during setup, and thus the media guidance application may already be authorized. Once access is established, the media guidance application may send commands and requests to the home security application, and may receive feedback and requests from the home security application.

In some embodiments, the media guidance application may receive, from the home security application, information about the location of the user. The home security application may obtain the information relating to the location of the user in many ways. For example, the home security application may use cameras of home security components 112 to determine whether any user is in a given room of home 100. The home security application may then use facial recognition technology to determine the identity of each user within home 100. For example, the home security application may detecting facial characteristics of an unidentified person in home 100 in order to identify the unidentified person. The facial characteristics may be compared to known facial characteristics of various residents or regular visitors to home 100 (e.g., the facial characteristics of these people may be stored in profiles of the users in a database).

There are other ways for home security components 112 to be used to identify a location of user 110. For example, a microphone of home security components 112 may be used, where voice of a person is detected, and characteristics of that voice are used to determine the identity of the person speaking. If the identity of the person speaking is person 110, and the sensor is in kitchen 108, then the media guidance application may determine that person 110 is in kitchen 108. Any other sensor may be used to detect location such as a weight sensor that detects a person of a weight is in a room, where each person in home 100 has a given weight. Indoor location technology may be used as well, where RFID sensors, signal strength sensors, compasses, and the like are employed to detect where in the home the user is based on an interaction with a device carried or worn by the user.

Using any of the above-mentioned techniques, the media guidance application may determine which room of home 100 person 110 is within. In the example depicted in FIG. 1, person 110 is within kitchen 108. Thus, with the knowledge of where in home 100 person 110 is, the media guidance application may cause, using the media guidance application, a home security component of home security components 112 of the room the user is in (in this case, kitchen 108) to alert the user that the media event is beginning. For example, a speaker may sound an alert to the user, or a display screen may be used to display to the user an alert that the media event is beginning.

In some embodiments, the media guidance application may, when causing the speaker of the plurality of speakers that is within the respective room to alert the user that the media event is beginning, cause no other speaker of the plurality of speakers to sound an alert that the media event is beginning. For example, as described in the background section, in the related art an entire home may be alerted when a given event occurs. In this embodiment, however, the alert will be targeted to person 110. For example, if a user is in kitchen 108, but there are, e.g., speakers in the living room, the media guidance application may cause the speaker of home security components 112 in kitchen 108 to alert the user, but may ensure that a speaker of home security components 112 in living room 102 does not issue an alert. Thus, person 110 receives the alert, while person 106 is not disturbed by the alert.

In some embodiments, in order to sound targeted alerts using home security components 112 in some rooms of home 100, while excluding other rooms of home 100, the media guidance application may generate a command that addresses the kitchen speaker, and is sent directly to the kitchen speaker (perhaps through a home security system gateway or gatekeeper). This may be accomplished by assigning home security components 112 individual addresses, or at least address masks that identify a room a home security component is within. By using specific addressing, the media guidance application can target alerts to particular devices, or clusters of devices in particular rooms of home 100, and avoid broadcasting an alert throughout home 100.

In some embodiments, rather than target specific devices through addressing, the media guidance application may transmit alerts globally to all home security components 112 of home 100. The home security components themselves may perform filtering operations in deciding whether or not to sound the alert. For example, home security components 112 may determine that an alert is targeted to a specific individual, and may determine whether that specific individual is in the same room as a given one of home security components 112 (using the processes and systems described above). If the user is not in the same room, the home security components 112 will not generate an alert in that room; otherwise, an alert will be generated.

In some embodiments, the media guidance application may detect that a plurality of users whose profiles indicate that they would enjoy the media event are not consuming the media at the given time. For example, if media corresponding to the media event is playing on user equipment 104 in living room 102, and users 106 and 110 are not in living room 102, where user 110 is in kitchen 108 and user 106 is in the den of home 100 (not depicted), the media guidance application may determine that neither user 106 nor user 110 is viewing the media. The media guidance application may identify a plurality of respective rooms within which the plurality of users are located at the given time using any of the methods described above and below. The media guidance application may thus cause speakers in the den and the kitchen to alert those users that the media event is beginning, and may, in some embodiments, not cause any other speakers or media components in other areas of home 100 to sound the alert.

In some embodiments, the media guidance application may actively determine that a user whose profile reflects that he or she would not enjoy the media corresponding to the media event is in home 100. For example, the media guidance application may determine that person 106 is enjoying a video playing back on user equipment 104 that is not the media corresponding to the media event. The media guidance application may further determine that person 106 does not wish to view media corresponding to the media event (e.g., based on person 104's profile). The media guidance application may reactively determine that person 106 is in living room 102, and may ensure that no alert is output from home security components 112 in living room 102. Each element of this process may be performed in any manner described above or below. This process may be scaled, such that the media guidance application may actively ensure that users whose profiles do not indicate an affinity for a media event not be alerted about that media event by a component of the home security system.

In some embodiments, the media guidance application may detect a voice command from the user that indicates a desire to consume the media relating to the media event. For example, after receiving an alert in kitchen 108 from home security components 112 of kitchen 108, person 110 may interact with home security components 112. Person 110 may interact with home security components 112 in any known manner, such as speaking a voice command (e.g., “PLAY THE MEDIA ON MY TABLET”), by typing a command into a dedicated interface (e.g., keyboard or touch screen) of home security components 112, and/or by using a user equipment (e.g., mobile device) to transmit the command (e.g., by way of an application installed on the user equipment that is specifically designed to interface with the home security application). The media guidance application, in response to detecting the interaction (e.g., voice command), may identify a nearest device to the user that is suitable for consuming the media (e.g., the nearest tablet device owned by person 110, following the example from above), and may cause the media to be generated for display at the nearest device. As another example, person 110 may be in kitchen 108, and may issue a generic command of, “PLAY THE MEDIA EVENT HERE IN THE KITCHEN.” In response, the media guidance application may determine that there is a tablet computer in the kitchen that is suitable for playing back the media event, and may cause the tablet to generate for display the media event. As another example, the media guidance application may utilize a monitor dedicated to the home security system (e.g., a monitor that shows security camera footage) to play back the media event.

In some embodiments, the media guidance application, home security application, and/or home security components 112 of a given room of home 100 may detect an interaction from person 110 (e.g., voice command) that indicates a desire to listen to an audio component relating to the media event while the user is in the given room (e.g., kitchen 108). The media guidance application may thus reactively transmit the audio component to the speaker, and may cause the speaker to output the audio component of the media. For example, if the media event is a sporting match, and person 110 is busy cooking in kitchen 108 and does not wish to view a screen but nevertheless wishes to listen to an event, person 110 may command the media guidance application to output (e.g., through home security components 112 of kitchen 108) an audio component of the media. Thus, the announcers of the sporting match may be heard over the speakers of the home security system. Similarly, the user may wish to see video but not hear audio (e.g., because a child is sleeping). The user may make such a command, and the media guidance application may responsively turn on a display device but disable the audio.

In some embodiments, the media guidance application may detect conditions that alter the way the media guidance application uses home security components 112 to issue alerts to a user. For example, the media guidance application may determine that it is a late hour (e.g., 1:00 am) and thus that residents of home 100 are likely to be sleeping. Thus, the media guidance application may issue silent alerts (e.g., using display devices but not audio), or low volume alerts, to a user in order to avoid awaking residents of home 100 whom are sleeping. As another example, the media guidance application may detect that a baby is in the room (e.g., using a camera of home security components 112), and may again issue silent or low volume alerts to avoid awaking the baby. Any such condition may be used to alter the manner in which alerts are output by home security components 112. These conditions may be programmed by default, or set up by a user.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices.

Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), on-demand information, blogs, websites, and any other type of guidance data that is helpful for a user to navigate among and locate desired content selections.

FIGS. 2-3 show illustrative display screens that may be used to provide media guidance data. The display screens shown in FIGS. 2-3 may be implemented on any suitable user equipment device or platform. While the displays of FIGS. 2-3 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 2 shows illustrative grid of a program listings display 200 arranged by time and channel that also enables access to different types of content in a single display. Display 200 may include grid 202 with: (1) a column of channel/content type identifiers 204, where each channel/content type identifier (which is a cell in the column) identifies a different channel or content type available; and (2) a row of time identifiers 206, where each time identifier (which is a cell in the row) identifies a time block of programming. Grid 202 also includes cells of program listings, such as program listing 208, where each listing provides the title of the program provided on the listing's associated channel and time. With a user input device, a user can select program listings by moving highlight region 210. Information relating to the program listing selected by highlight region 210 may be provided in program information region 212. Region 212 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 202 may provide media guidance data for non-linear programming including on-demand listing 214, recorded content listing 216, and Internet content listing 218. A display combining media guidance data for content from different types of content sources is sometimes referred to as a “mixed-media” display. Various permutations of the types of media guidance data that may be displayed that are different than display 200 may be based on user selection or guidance application definition (e.g., a display of only recorded and broadcast listings, only on-demand and broadcast listings, etc.). As illustrated, listings 214, 216, and 218 are shown as spanning the entire time block displayed in grid 202 to indicate that selection of these listings may provide access to a display dedicated to on-demand listings, recorded listings, or Internet listings, respectively. In some embodiments, listings for these content types may be included directly in grid 202. Additional media guidance data may be displayed in response to the user selecting one of the navigational icons 220. (Pressing an arrow key on a user input device may affect the display in a similar manner as selecting navigational icons 220.)

Display 200 may also include video region 222, and options region 226. Video region 222 may allow the user to view and/or preview programs that are currently available, will be available, or were available to the user. The content of video region 222 may correspond to, or be independent from, one of the listings displayed in grid 202. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Options region 226 may allow the user to access different types of content, media guidance application displays, and/or media guidance application features. Options region 226 may be part of display 200 (and other display screens described herein), or may be invoked by a user by selecting an on-screen option or pressing a dedicated or assignable button on a user input device. The selectable options within options region 226 may concern features related to program listings in grid 202 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 5. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 3. Video mosaic display 300 includes selectable options 302 for content information organized based on content type, genre, and/or other organization criteria. In display 300, television listings option 304 is selected, thus providing listings 306, 308, 310, and 312 as broadcast program listings. In display 300 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 308 may include more than one portion, including media portion 314 and text portion 316. Media portion 314 and/or text portion 316 may be selectable to view content in full-screen or to view information related to the content displayed in media portion 314 (e.g., to view listings for the channel that the video is displayed on).

The listings in display 300 are of different sizes (i.e., listing 306 is larger than listings 308, 310, and 312), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

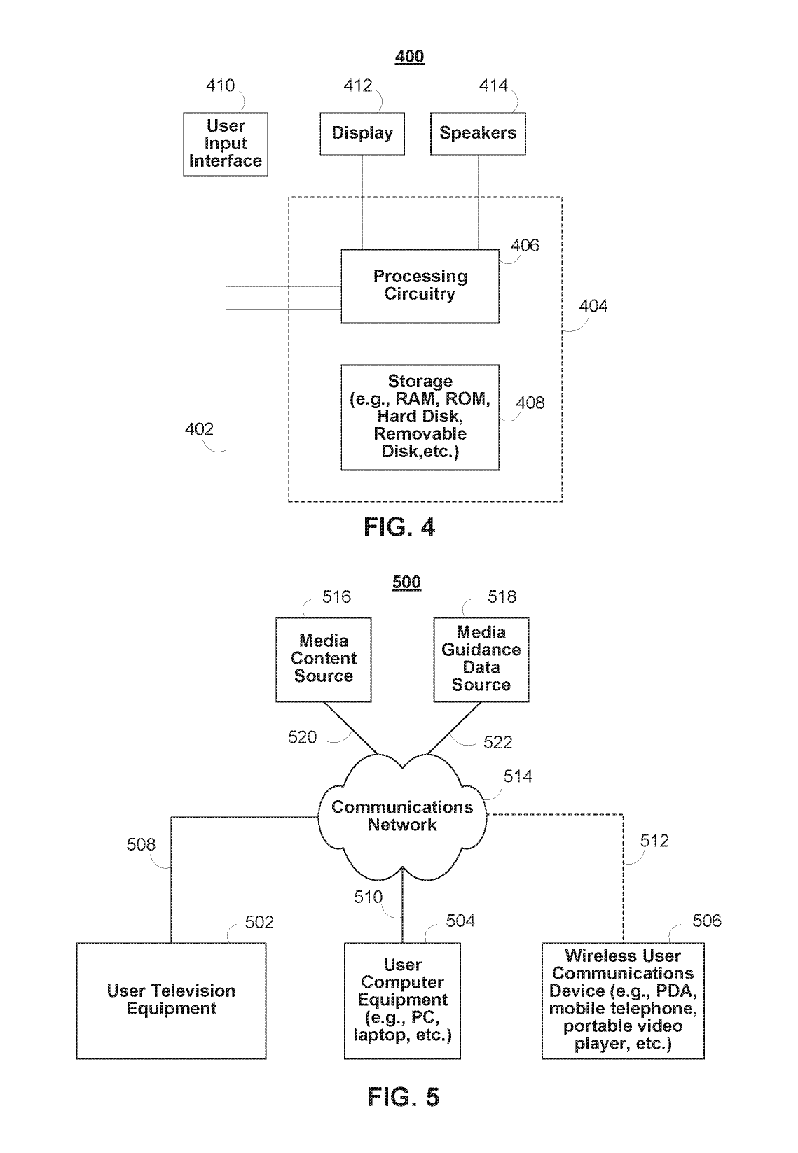

Users may access content and the media guidance application (and its display screens described above and below) from one or more of their user equipment devices. FIG. 4 shows a generalized embodiment of illustrative user equipment device 400. More specific implementations of user equipment devices are discussed below in connection with FIG. 5. User equipment device 400 may receive content and data via input/output (hereinafter “I/O”) path 402. I/O path 402 may provide content (e.g., broadcast programming, on-demand programming, Internet content, content available over a local area network (LAN) or wide area network (WAN), and/or other content) and data to control circuitry 404, which includes processing circuitry 406 and storage 408. Control circuitry 404 may be used to send and receive commands, requests, and other suitable data using I/O path 402. I/O path 402 may connect control circuitry 404 (and specifically processing circuitry 406) to one or more communications paths (described below). I/O functions may be provided by one or more of these communications paths, but are shown as a single path in FIG. 4 to avoid overcomplicating the drawing.

Control circuitry 404 may be based on any suitable processing circuitry such as processing circuitry 406. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 404 executes instructions for a media guidance application stored in memory (i.e., storage 408). Specifically, control circuitry 404 may be instructed by the media guidance application to perform the functions discussed above and below. For example, the media guidance application may provide instructions to control circuitry 404 to generate the media guidance displays. In some implementations, any action performed by control circuitry 404 may be based on instructions received from the media guidance application.

In client-server based embodiments, control circuitry 404 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 5). In addition, communications circuitry may include circuitry that enables peer-to-peer communication of user equipment devices, or communication of user equipment devices in locations remote from each other (described in more detail below).

Memory may be an electronic storage device provided as storage 408 that is part of control circuitry 404. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 408 may be used to store various types of content described herein as well as media guidance data described above. Nonvolatile memory may also be used (e.g., to launch a boot-up routine and other instructions). Cloud-based storage, described in relation to FIG. 5, may be used to supplement storage 408 or instead of storage 408.

Control circuitry 404 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 404 may also include scaler circuitry for upconverting and downconverting content into the preferred output format of the user equipment 400. Circuitry 404 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 408 is provided as a separate device from user equipment 400, the tuning and encoding circuitry (including multiple tuners) may be associated with storage 408.

A user may send instructions to control circuitry 404 using user input interface 410. User input interface 410 may be any suitable user interface, such as a remote control, mouse, trackball, keypad, keyboard, touch screen, touchpad, stylus input, joystick, voice recognition interface, or other user input interfaces. Display 412 may be provided as a stand-alone device or integrated with other elements of user equipment device 400. For example, display 412 may be a touchscreen or touch-sensitive display. In such circumstances, user input interface 410 may be integrated with or combined with display 412. Display 412 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 412 may be HDTV-capable. In some embodiments, display 412 may be a 3D display, and the interactive media guidance application and any suitable content may be displayed in 3D. A video card or graphics card may generate the output to the display 412. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 404. The video card may be integrated with the control circuitry 404. Speakers 414 may be provided as integrated with other elements of user equipment device 400 or may be stand-alone units. The audio component of videos and other content displayed on display 412 may be played through speakers 414. In some embodiments, the audio may be distributed to a receiver (not shown), which processes and outputs the audio via speakers 414.

The guidance application may be implemented using any suitable architecture. For example, it may be a stand-alone application wholly-implemented on user equipment device 400. In such an approach, instructions of the application are stored locally (e.g., in storage 408), and data for use by the application is downloaded on a periodic basis (e.g., from an out-of-band feed, from an Internet resource, or using another suitable approach). Control circuitry 404 may retrieve instructions of the application from storage 408 and process the instructions to generate any of the displays discussed herein. Based on the processed instructions, control circuitry 404 may determine what action to perform when input is received from input interface 410. For example, movement of a cursor on a display up/down may be indicated by the processed instructions when input interface 410 indicates that an up/down button was selected.

In some embodiments, the media guidance application is a client-server based application. Data for use by a thick or thin client implemented on user equipment device 400 is retrieved on-demand by issuing requests to a server remote to the user equipment device 400. In one example of a client-server based guidance application, control circuitry 404 runs a web browser that interprets web pages provided by a remote server. For example, the remote server may store the instructions for the application in a storage device. The remote server may process the stored instructions using circuitry (e.g., control circuitry 404) and generate the displays discussed above and below. The client device may receive the displays generated by the remote server and may display the content of the displays locally on equipment device 400. This way, the processing of the instructions is performed remotely by the server while the resulting displays are provided locally on equipment device 400. Equipment device 400 may receive inputs from the user via input interface 410 and transmit those inputs to the remote server for processing and generating the corresponding displays. For example, equipment device 400 may transmit a communication to the remote server indicating that an up/down button was selected via input interface 410. The remote server may process instructions in accordance with that input and generate a display of the application corresponding to the input (e.g., a display that moves a cursor up/down). The generated display is then transmitted to equipment device 400 for presentation to the user.

In some embodiments, the media guidance application is downloaded and interpreted or otherwise run by an interpreter or virtual machine (run by control circuitry 404). In some embodiments, the guidance application may be encoded in the ETV Binary Interchange Format (EBIF), received by control circuitry 404 as part of a suitable feed, and interpreted by a user agent running on control circuitry 404. For example, the guidance application may be an EBIF application. In some embodiments, the guidance application may be defined by a series of JAVA-based files that are received and run by a local virtual machine or other suitable middleware executed by control circuitry 404. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 400 of FIG. 4 can be implemented in system 500 of FIG. 5 as user television equipment 502, user computer equipment 504, wireless user communications device 506, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 4 may not be classified solely as user television equipment 502, user computer equipment 504, or a wireless user communications device 506. For example, user television equipment 502 may, like some user computer equipment 504, be Internet-enabled allowing for access to Internet content, while user computer equipment 504 may, like some television equipment 502, include a tuner allowing for access to television programming. The media guidance application may have the same layout on various different types of user equipment or may be tailored to the display capabilities of the user equipment. For example, on user computer equipment 504, the guidance application may be provided as a web site accessed by a web browser. In another example, the guidance application may be scaled down for wireless user communications devices 506.

In system 500, there is typically more than one of each type of user equipment device but only one of each is shown in FIG. 5 to avoid overcomplicating the drawing. In addition, each user may utilize more than one type of user equipment device and also more than one of each type of user equipment device.

In some embodiments, a user equipment device (e.g., user television equipment 502, user computer equipment 504, wireless user communications device 506) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 514. Namely, user television equipment 502, user computer equipment 504, and wireless user communications device 506 are coupled to communications network 514 via communications paths 508, 510, and 512, respectively. Communications network 514 may be one or more networks including the Internet, a mobile phone network, mobile voice or data network (e.g., a 4G or LTE network), cable network, public switched telephone network, or other types of communications network or combinations of communications networks. Paths 508, 510, and 512 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 512 is drawn with dotted lines to indicate that in the exemplary embodiment shown in FIG. 5 it is a wireless path and paths 508 and 510 are drawn as solid lines to indicate they are wired paths (although these paths may be wireless paths, if desired). Communications with the user equipment devices may be provided by one or more of these communications paths, but are shown as a single path in FIG. 5 to avoid overcomplicating the drawing.

Although communications paths are not drawn between user equipment devices, these devices may communicate directly with each other via communication paths, such as those described above in connection with paths 508, 510, and 512, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 514.

System 500 includes content source 516 and media guidance data source 518 coupled to communications network 514 via communication paths 520 and 522, respectively. Paths 520 and 522 may include any of the communication paths described above in connection with paths 508, 510, and 512. Communications with the content source 516 and media guidance data source 518 may be exchanged over one or more communications paths, but are shown as a single path in FIG. 5 to avoid overcomplicating the drawing. In addition, there may be more than one of each of content source 516 and media guidance data source 518, but only one of each is shown in FIG. 5 to avoid overcomplicating the drawing. (The different types of each of these sources are discussed below.) If desired, content source 516 and media guidance data source 518 may be integrated as one source device. Although communications between sources 516 and 518 with user equipment devices 502, 504, and 506 are shown as through communications network 514, in some embodiments, sources 516 and 518 may communicate directly with user equipment devices 502, 504, and 506 via communication paths (not shown) such as those described above in connection with paths 508, 510, and 512.

Content source 516 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 516 may be the originator of content (e.g., a television broadcaster, a Webcast provider, etc.) or may not be the originator of content (e.g., an on-demand content provider, an Internet provider of content of broadcast programs for downloading, etc.). Content source 516 may include cable sources, satellite providers, on-demand providers, Internet providers, over-the-top content providers, or other providers of content. Content source 516 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 518 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 518 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 518 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 518 may provide user equipment devices 502, 504, and 506 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 408, and executed by control circuitry 404 of a user equipment device 400. In some embodiments, media guidance applications may be client-server applications where only a client application resides on the user equipment device, and server application resides on a remote server. For example, media guidance applications may be implemented partially as a client application on control circuitry 404 of user equipment device 400 and partially on a remote server as a server application (e.g., media guidance data source 518) running on control circuitry of the remote server. When executed by control circuitry of the remote server (such as media guidance data source 518), the media guidance application may instruct the control circuitry to generate the guidance application displays and transmit the generated displays to the user equipment devices. The server application may instruct the control circuitry of the media guidance data source 518 to transmit data for storage on the user equipment. The client application may instruct control circuitry of the receiving user equipment to generate the guidance application displays.

Content and/or media guidance data delivered to user equipment devices 502, 504, and 506 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 500 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 5.

In one approach, user equipment devices may communicate with each other within a home network. User equipment devices can communicate with each other directly via short-range point-to-point communication schemes described above, via indirect paths through a hub or other similar device provided on a home network, or via communications network 514. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 516 to access content. Specifically, within a home, users of user television equipment 502 and user computer equipment 504 may access the media guidance application to navigate among and locate desirable content. Users may also access the media guidance application outside of the home using wireless user communications devices 506 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 514. These cloud resources may include one or more content sources 516 and one or more media guidance data sources 518. In addition or in the alternative, the remote computing sites may include other user equipment devices, such as user television equipment 502, user computer equipment 504, and wireless user communications device 506. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 504 or wireless user communications device 506 having content capture feature. Alternatively, the user can first transfer the content to a user equipment device, such as user computer equipment 504. The user equipment device storing the content uploads the content to the cloud using a data transmission service on communications network 514. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 4.

As referred herein, the term “in response to” refers to initiated as a result of. For example, a first action being performed in response to a second action may include interstitial steps between the first action and the second action. As referred herein, the term “directly in response to” refers to caused by. For example, a first action being performed directly in response to a second action may not include interstitial steps between the first action and the second action.

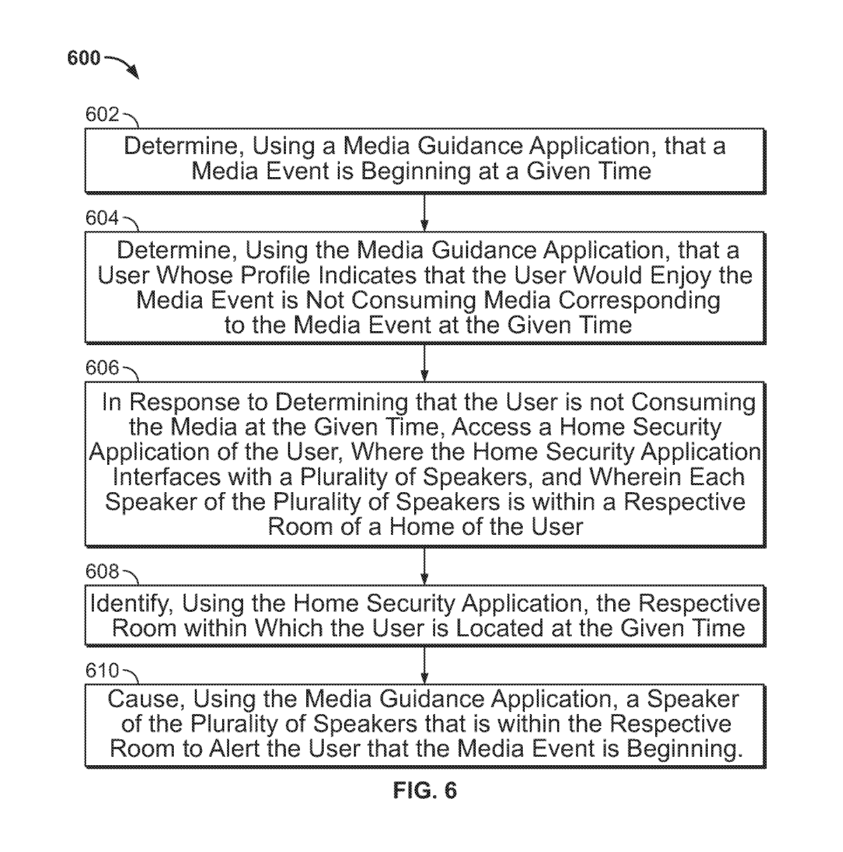

FIG. 6 depicts an illustrative flowchart of a process for using a home security system to alert a user that a media event the user is likely to enjoy is about to begin, in accordance with some embodiments of the disclosure. Process 600 begins at 602, where a media guidance application may determine that a media event is beginning at a given time. The media guidance application may be executed by control circuitry 404 of user equipment (e.g., user equipment 104, user television equipment 502, user computer equipment 504, wireless user communications device 506, user equipment for interfacing with a home security system, or any other user equipment), or alternatively may be executed by control circuitry 404 of a server. Manners in which the media guidance application may determine that a media event is beginning at a given time are discussed above and apply equally to process 600.

Process 600 continues to 604, where the media guidance application may determine that a user whose profile indicates that the user would enjoy the media event is not consuming media corresponding to the media event at the given time. Manners in which this determination may be made by the media guidance application are described above and apply equally here. For example, the media guidance application may determine that person 110 is not in living room 102, where user equipment 104 is playing back the media, and thus that person 106 is not viewing the media. Profile data may be stored in, and retrieved from, local storage 408 of user equipment, or remote storage (e.g., media guidance data source 518, or media content source 516), accessible by way of a communications network (e.g., communications network 514).

Process 600 continues to 606, where the media guidance application, in response to determining that the user is not consuming the media at the given time, may access a home security application of the user. The home security application may interface with a plurality of home security components 112 (e.g., speakers), where each home security component of the plurality of home security components 112 is within a respective room of a home (e.g., home 100) of the user.

Process 600 may continue to 608, where the media guidance application may identify, using the home security application, the respective room within which the user is located at the given time. For example, the media guidance application may use home security components 112 of kitchen 108, such as a camera or microphone, as described above, to determine that person 110 is within kitchen 108 at the given time.

Process 600 may then continue to 610, where the media guidance application may cause a home security component of home security components 112 that is within the respective room (e.g., a speaker of home security components 112 that is within kitchen 108) to alert the user that the media event is beginning. For example, a speaker or display within kitchen 108 may alert the user of the media event. Home security components 112 may, for example, sound an alert by way of speakers 414 and/or display 412, and may interface with a user by way of user input interface 410.

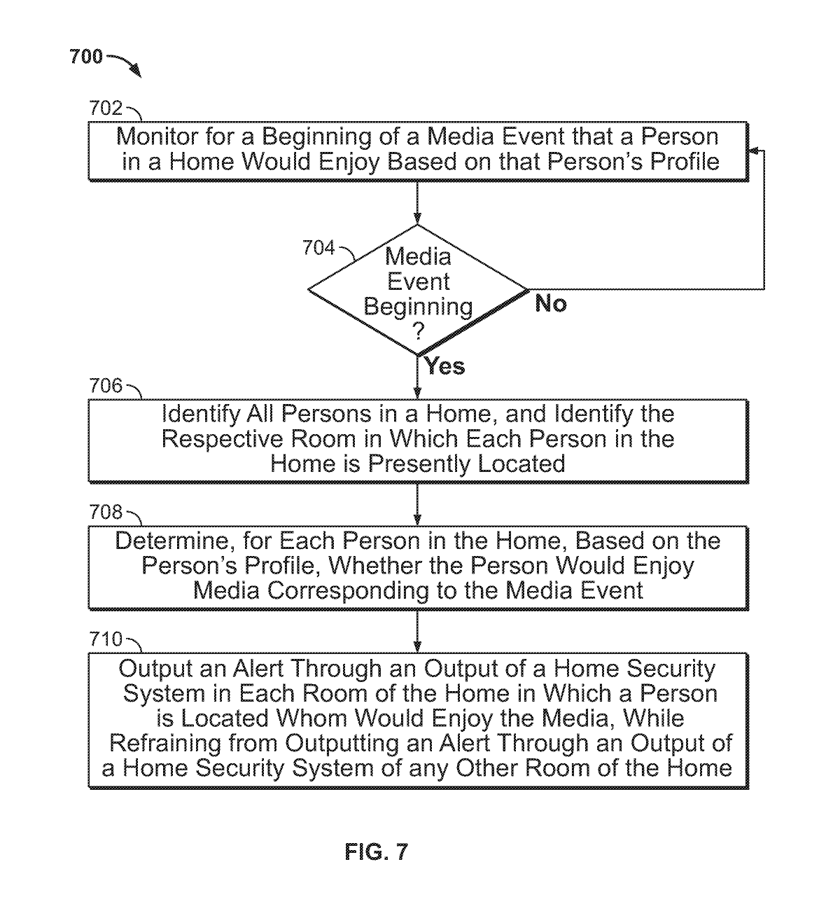

FIG. 7 depicts an illustrative flowchart of a process for using a home security system to output an alert that media is beginning in rooms of a home where users are likely to enjoy the media, and not in rooms where users are unlikely to enjoy the media, in accordance with some embodiments of the disclosure. Process 700 begins at 702, where the media guidance application may monitor for a beginning of a media event that a person in a home would enjoy based on that person's profile. Detecting a beginning of a media asset, and determining which media assets a person may enjoy, are described above and apply equally here. At 704, the media guidance application may determine that such a media event is not beginning, which reverts process 700 back to 702 where the monitoring continues. Alternatively, at 704, the media guidance application may determine that such a media event is beginning, in which case process 700 continues to 706.

At 706, the media guidance application may identify all persons in a home, and identify the respective room in which each person in the home is presently located. For example, the media guidance application may identify two persons in the home (e.g., person 106 and person 110). The media guidance application may identify that person 106 is in living room 102, and that person 110 is in kitchen 108. Identifying persons and locations in a home in which a person presently is located is described above and applies equally here.

Process 700 continues to 708, where the media guidance application may determine, for each person in the home, based on the person's profile, whether the person would enjoy media corresponding to the media event. For example, the media guidance application may determine that person 110 would enjoy the media, and that person 106 would not enjoy the media. This determination may be performed using any manner described above.

Process 700 may continue to 710, where the media guidance application may output an alert through an output of a home security system (e.g., home security components 112) in each room of the home in which a person is located whom would enjoy the media (e.g., kitchen 108), while refraining from outputting an alert through an output of a home security system of any other room of the home (e.g., living room 102). In some embodiments, multiple persons may be located in a given room, where some persons would enjoy the media, and others would not. In some cases, the media guidance application may sound the alert so long as one person would enjoy the media. In other cases, the media guidance application may refrain from sounding the alert unless there are more people who would enjoy the media than who would not enjoy the media. Any number of conditions may be set for sounding the alert, and these conditions may be set by a user who manages the home security application, and/or by factory or default settings.

It should be noted that processes 600-700 or any step thereof could be performed on, or provided by, any of the devices shown in FIGS. 1 and 4-5. For example, any of processes 600-700 may be executed by control circuitry 404 (FIG. 4) as instructed by control circuitry implemented on user equipment 502, 504, 506 (FIG. 5), and/or a user equipment for interfacing with a home security application, in order to sound an alarm in an appropriate room of a home. In addition, one or more steps of processes 600-700 may be incorporated into or combined with one or more steps of any other process or embodiment.

It is contemplated that the steps or descriptions of each of FIGS. 6-7 may be used with any other embodiment of this disclosure. In addition, the steps and descriptions described in relation to FIGS. 6-7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 1 and 4-5 could be used to perform one or more of the steps in FIGS. 6-7.

It will be apparent to those of ordinary skill in the art that methods involved in the present invention may be embodied in a computer program product that includes a computer-usable and/or readable medium. For example, such a computer-usable medium may consist of a read-only memory device, such as a CD-ROM disk or conventional ROM device, or a random access memory, such as a hard drive device or a computer diskette, having a computer-readable program code stored thereon. It should also be understood that methods, techniques, and processes involved in the present disclosure may be executed using processing circuitry. For instance, determining a room in a home in which a user is located may be performed, e.g., by processing circuitry 406 of FIG. 4. The processing circuitry, for instance, may be a general purpose processor, a customized integrated circuit (e.g., an ASIC), or a field-programmable gate array (FPGA) within user equipment 400, media content source 516, or media guidance data source 518. For example, a profile, as described herein, may be stored in, and retrieved from, storage 408 of FIG. 4, or media guidance data source 518 of FIG. 5. Furthermore, processing circuitry, or a computer program, may update settings of the home security application, such as volume settings or time restriction settings, stored within storage 408 of FIG. 4 or media guidance data source 518 of FIG. 5.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

While some portions of this disclosure may make reference to “convention,” any such reference is merely for the purpose of providing context to the invention(s) of the instant disclosure, and does not form any admission as to what constitutes the state of the art.

1. (canceled)

2. A method for alerting a user about a media event using a home security application of the user, the method comprising:
determining, using a media guidance application, that a media event is beginning at a given time;
determining, using the media guidance application, that a user whose profile indicates that the user would enjoy the media event is not consuming media corresponding to the media event at the given time;
in response to determining that the user is not consuming the media at the given time:
accessing a home security application of the user, wherein the home security application interfaces with a plurality of speakers, and wherein each speaker of the plurality of speakers is within a respective room of a home of the user, and
identifying, using the home security application, the respective room within which the user is located at the given time; and
causing, using the media guidance application, a speaker of the plurality of speakers that is within the respective room to alert the user that the media event is beginning.

3. The method of claim 2, further comprising:
detecting, using the media guidance application, that a plurality of users whose profiles indicate that they would enjoy the media corresponding to the media event are not consuming the media event at the given time;
identifying, using the home security application, a plurality of respective rooms within which the plurality of users are located at the given time; and
causing, using the media guidance application, speakers associated with the home security application in each of the plurality of respective rooms, to alert the plurality of users that the media event is beginning.

4. The method of claim 2, further comprising:
determining, using the media guidance application, that a different user whose profile indicates that the different user would not enjoy the media is not consuming the media at the given time;
in response to determining that the different user is not consuming the media at the given time:
identifying, using the home security application, the respective room within which the different user is located at the given time; and
causing, using the media guidance application, a speaker of the plurality of speakers that is within the respective room within which the different user is located at the given time to refrain from alerting the different user that the media event is beginning.

5. The method of claim 2, wherein causing, using the media guidance application, the speaker of the plurality of speakers that is within the respective room to alert the user that the media event is beginning, comprises causing no other speaker of the plurality of speakers to sound an alert that the media event is beginning.

6. The method of claim 2, wherein accessing the home security application of the user comprises:
initiating a communication between the media guidance application and the home security application;
receiving, by the media guidance application, from the home security application, information about the location of the user; and
enabling the media guidance application to issue alerts through the plurality of speakers.

7. The method of claim 2, wherein identifying, using the home security application, the respective room within which the user is located at the given time comprises:
accessing a plurality of cameras with which the home security application interfaces;
detecting, while accessing the plurality of cameras, an unidentified person in the respective room;
detecting facial characteristics of the unidentified person;
identifying the unidentified person as the user based on the facial characteristics; and
identifying the respective room based on the identifying of the unidentified person as the user.

8. The method of claim 7, wherein each of the plurality of speakers and the plurality of cameras is hardwired into the home of the user.

9. The method of claim 2, wherein causing, using the media guidance application, the speaker of the plurality of speakers that is within the respective room to alert the user that the media event is beginning comprises:
in response to identifying, using the home security application, the respective room within which the user is located at the given time, generating, using the media guidance application, a command; and
transmitting, using the media guidance application, the command to the home security application, wherein the home security application, upon receiving the command, causes the speaker to alert the user that the media event is beginning.

10. The method of claim 2, further comprising:
detecting a voice command from the user that indicates a desire to consume the media;
in response to detecting the voice command, identifying, using the home security application, a nearest device to the user that is suitable for consuming the media; and
causing the media to be generated for display at the nearest device.

11. The method of claim 2, further comprising:
detecting a voice command that indicates a desire to listen to an audio component relating to the media while the user is in the respective room;
transmitting, using the media guidance application, the audio component to the speaker; and
causing the speaker to output the audio component of the media.

12. A system for alerting a user about a media event using a home security application of the user, the system comprising:
a plurality of speakers, wherein each speaker of the plurality of speakers is within a respective room of a home of a user;
communications circuitry; and
control circuitry configured to:
determine, using a media guidance application, that a media event is beginning at a given time;
determine, using the media guidance application, that the user, whose profile indicates that the user would enjoy the media event, is not consuming media corresponding to the media event at the given time;
in response to determining that the user is not consuming the media at the given time:
access a home security application of the user, wherein the home security application interfaces with the plurality of speakers, and
identify, using the home security application, the respective room within which the user is located at the given time; and
cause, using the media guidance application, a speaker of the plurality of speakers that is within the respective room to alert the user that the media event is beginning.

13. The system of claim 12, wherein the control circuitry is further configured to:
detect, using the media guidance application, that a plurality of users whose profiles indicate that they would enjoy the media corresponding to the media event are not consuming the media event at the given time;
identify, using the home security application, a plurality of respective rooms within which the plurality of users are located at the given time; and
cause, using the media guidance application, speakers associated with the home security application in each of the plurality of respective rooms, to alert the plurality of users that the media event is beginning.

14. The system of claim 12, wherein the control circuitry is further configured to:
determine, using the media guidance application, that a different user whose profile indicates that the different user would not enjoy the media is not consuming the media at the given time;
in response to determining that the different user is not consuming the media at the given time:
identify, using the home security application, the respective room within which the different user is located at the given time; and
cause, using the media guidance application, a speaker of the plurality of speakers that is within the respective room within which the different user is located at the given time to refrain from alerting the different user that the media event is beginning.

15. The system of claim 12, wherein the control circuitry is further configured, when causing, using the media guidance application, the speaker of the plurality of speakers that is within the respective room to alert the user that the media event is beginning, to cause no other speaker of the plurality of speakers to sound an alert that the media event is beginning.

16. The system of claim 12, wherein the control circuitry is further configured, when accessing the home security application of the user, to:
initiate a communication between the media guidance application and the home security application;
receive, by the media guidance application, from the home security application, information about the location of the user; and
enable the media guidance application to issue alerts through the plurality of speakers.

17. The system of claim 12, wherein the control circuitry is further configured, when identifying, using the home security application, the respective room within which the user is located at the given time, to:
access a plurality of cameras with which the home security application interfaces;
detect, while accessing the plurality of cameras, an unidentified person in the respective room;
detect facial characteristics of the unidentified person;
identify the unidentified person as the user based on the facial characteristics; and
identify the respective room based on the identifying of the unidentified person as the user.

18. The system of claim 17, wherein each of the plurality of speakers and the plurality of cameras is hardwired into the home of the user.

19. The system of claim 12, wherein the control circuitry is further configured, when causing, using the media guidance application, the speaker of the plurality of speakers that is within the respective room to alert the user that the media event is beginning, to:
in response to identifying, using the home security application, the respective room within which the user is located at the given time, generate, using the media guidance application, a command; and
transmit, using the media guidance application, the command to the home security application, wherein the home security application, upon receiving the command, causes the speaker to alert the user that the media event is beginning.

20. The system of claim 12, wherein the control circuitry is further configured to:
detect a voice command from the user that indicates a desire to consume the media;
in response to detecting the voice command, identify, using the home security application, a nearest device to the user that is suitable for consuming the media; and
cause the media to be generated for display at the nearest device.

21. The system of claim 12, wherein the control circuitry is further configured to:
detect a voice command that indicates a desire to listen to an audio component relating to the media while the user is in the respective room;
transmit, using the media guidance application, the audio component to the speaker; and
cause the speaker to output the audio component of the media.

22-51. (canceled)
